(19) United States
(12) Patent Application Publication
(10) Pub. No.: US 2025/0087381 A1
(43) Pub. Date: Mar. 13, 2025

(54) MOLDED ELECTRICAL WIRE

(71) Applicant: Proterial, Ltd., Tokyo (JP)

(72) Inventor: Keisuke Sugita, Tokyo (JP)

(21) Appl. No.: 18/795,598

(22) Filed: Aug. 6, 2024

(30) Foreign Application Priority Data
Sep. 12, 2023 (JP) 2023-147512

(51) Int. Cl. H01B 3/28; H01B 3/30; H01B 3/42; H01B 3/44; H01B 7/02

(52) U.S. Cl. CPC H01B 3/28; H01B 3/302; H01B 3/421; H01B 3/44; H01B 7/02

(57) ABSTRACT

A molded electrical wire having high adhesiveness between an insulation member and a resin molded body is provided. A molded electrical wire includes: a conductor wire; a non-crosslinked insulation member covering an outer circumference of the conductor wire; and a resin molded body directly covering the insulation member. The insulation member contains a thermoplastic polyurethane and an acrylic thermoplastic elastomer. The resin molded body contains polybutylene terephthalate. The insulation member further contains, for example, polybutylene terephthalate or a polyester-based thermoplastic elastomer.

### CROSS-REFERENCE TO RELATED APPLICATIONS

The present international application claims priority based on Japanese Patent Application No. 2023-147512 filed to Japanese Patent Office on Sep. 12, 2023, and the content of Japanese Patent Application No. 2023-147512 is incorporated by reference in its entirety.

### BACKGROUND

The present disclosure relates to a molded electrical wire.

As disclosed in JP H10-233125 A and JP H10-294023 A, there is a known technique of protecting, using a resin molded body, a connection part between an electrical wire and a device component such as a sensor, an electrode terminal, or another electronic circuit (hereinafter called a connection target) and a periphery thereof.

When the connection target is especially an automobile, a robot, an electronic device, or the like, the connection target is required to have a high reliability. In order to enhance the reliability of the connection target, it is desirable that adhesiveness between the insulator of the electrical wire and the resin molded body is high.

### SUMMARY

Conventionally, a material of an insulator of an electrical wire has been thermoplastic polyurethane. It is conceivable to use inexpensive polybutylene terephthalate as a material of the resin molded body. When the material of the insulator is thermoplastic polyurethane and the material of the resin molded body is polybutylene terephthalate, adhesiveness between the insulator and the resin molded body has been insufficient.

In one phase of the present disclosure, it is preferable to provide a molded electrical wire having high adhesiveness between an insulation member of an electrical wire and a resin molded body.

One phase of the present disclosure is a molded electrical wire including: a conductor wire; a non-crosslinked insulation member covering an outer circumference of the conductor wire; and a resin molded body directly covering the insulation member, in which the insulation member contains a thermoplastic polyurethane and an acrylic thermoplastic elastomer, and the resin molded body contains polybutylene terephthalate.

In the molded electrical wire of one phase of the present disclosure, adhesiveness between the insulation member and the resin molded body is high even if the resin molded body contains polybutylene terephthalate.

### BRIEF DESCRIPTION OF THE DRAWINGS

Embodiments of the present disclosure will be described with reference to the drawings, in which:

FIG. 1A is a side view of a molded electrical wire of a first embodiment;

FIG. 1B is a side view of the molded electrical wire in a state where a resin molded body is cut in a longitudinal direction of the molded electrical wire;

FIG. 2 is a cross-sectional view of II-II cross-section in FIG. 1A;

FIG. 3 is a side view illustrating a configuration of a molded electrical wire of a second embodiment;

FIG. 4 is a cross-sectional view of IV-IV cross-section in FIG. 3;

FIG. 5A is a side cross-sectional view illustrating a configuration of a sample used in Examples; and

FIG. 5B is a schematic view illustrating a state where an airtightness test is conducted.

### DETAILED DESCRIPTION OF EXEMPLARY EMBODIMENTS

### First Embodiment

### 1. Configuration of Molded Electrical Wire 1

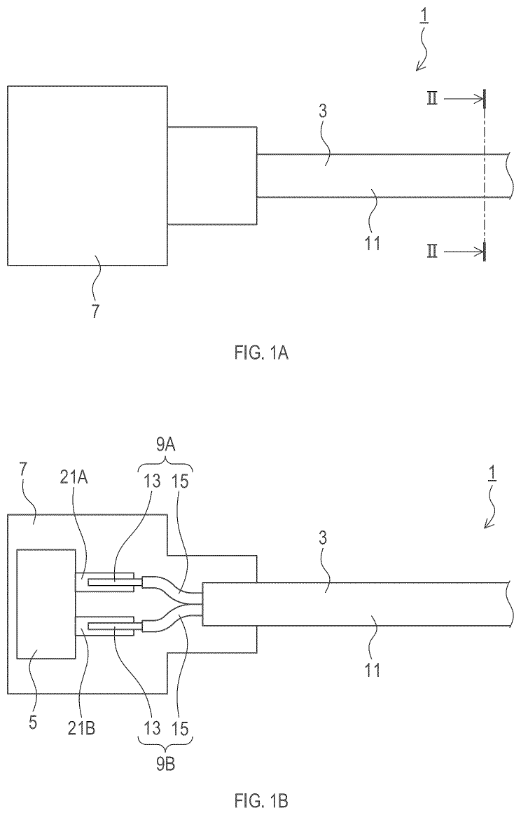

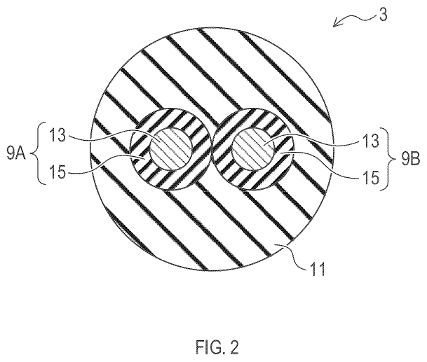

A configuration of a molded electrical wire 1 will be described with reference to FIGS. 1A, 1B, and 2. The molded electrical wire 1 can be used for, for example, an automobile, a robot, an electronic device, and the like. As shown in FIGS. 1A and 1B, the molded electrical wire 1 includes a cable 3, an electronic circuit 5, and a resin molded body 7.

As shown in FIG. 2, the cable 3 includes insulated electrical wires 9A and 9B and a sheath 11. The sheath 11 covers the insulated electrical wires 9A and 9B. The insulated electrical wire 9A includes a conductor wire 13 and an insulator 15. The conductor wire 13 is made of a conductive material such as copper or includes a conductive material such as copper.

The insulator 15 directly covers the outer circumference of the conductor wire 13. Directly covering the outer circumference means that the insulator 15 covers the outer circumference of the conductor wire 13, and the insulator 15 and the conductor wire 13 are in direct contact with each other. Directly covering the outer circumference is an aspect of covering the outer circumference. The insulated electrical wire 9B also has the same configuration as that of the insulated electrical wire 9A.

The sheath 11 indirectly covers the outer circumference of the conductor wire 13 of the insulated electrical wire 9A and the outer circumference of the conductor wire 13 of the insulated electrical wire 9B. Indirectly covering the outer circumference means that the sheath 11 covers the outer circumference of the conductor wire 13, the sheath 11 and the conductor wire 13 are not in direct contact with each other, and another member exists between them. In the present embodiment, the other member is the insulator 15. Indirectly covering the outer circumference is an aspect of covering the outer circumference. The sheath 11 and the insulator 15 correspond to an example of an insulation member.

As shown in FIG. 1B, the sheath 11 is removed at an end part of the cable 3, and the insulated electrical wires 9A and 9B are exposed. At the end parts of the insulated electrical wires 9A and 9B that are exposed, the insulator 15 is removed, and the conductor wire 13 is exposed.

As shown in FIG. 1B, the electronic circuit 5 includes electrode terminals 21A and 21B. The conductor wire 13 that is exposed in the insulated electrical wire 9A is electrically connected to the electrode terminal 21A. The conductor wire 13 that is exposed in the insulated electrical wire 9B is electrically connected to the electrode terminal 21B.

As shown in FIGS. 1A and 1B, the resin molded body 7 covers from the electronic circuit 5 to the end part of the sheath 11. The resin molded body 7 covers the entire electronic circuit 5. The resin molded body 7 directly covers the insulators 15 of the insulated electrical wires 9A and 9B in the part from which the sheath 11 has been removed. The resin molded body 7 directly covers the end part of the sheath 11.

The insulated electrical wires 9A and 9B in the part from which the sheath 11 is removed correspond to a plurality of insulated electrical wires. The insulated electrical wires 9A and 9B in the part from which the sheath 11 is removed are covered collectively with the resin molded body 7. The number of insulated electrical wires included in the cable 3 may be other than two, and may be, for example, one or three or more.

The sheath 11 contains a thermoplastic polyurethane and an acrylic thermoplastic elastomer. The sheath 11 further contains polybutylene terephthalate, for example, in addition to the thermoplastic polyurethane and the acrylic thermoplastic elastomer. In this case, adhesiveness between the sheath 11 and the resin molded body 7 is higher.

The sheath 11 further contains a polyester-based thermoplastic elastomer, for example, in addition to the thermoplastic polyurethane and the acrylic thermoplastic elastomer. In this case, adhesiveness between the sheath 11 and the resin molded body 7 is higher.

The sheath 11 further contains polybutylene terephthalate and a polyester-based thermoplastic elastomer, for example, in addition to the thermoplastic polyurethane and the acrylic thermoplastic elastomer. In this case, adhesiveness between the sheath 11 and the resin molded body 7 is higher.

When the total mass of the resin contained in the sheath 11 is 100 parts by mass, the mass of the thermoplastic polyurethane contained in the sheath 11 is preferably equal to or greater than 10 parts by mass and equal to or less than 90 parts by mass. In this case, adhesiveness between the sheath 11 and the resin molded body 7 is higher.

When the total mass of the resin contained in the sheath 11 is 100 parts by mass, the mass of the acrylic thermoplastic elastomer contained in the sheath 11 is preferably equal to or greater than 10 parts by mass and equal to or less than 90 parts by mass. In this case, adhesiveness between the sheath 11 and the resin molded body 7 is higher.

When the total mass of the resin contained in the sheath 11 is 100 parts by mass, the mass of the polybutylene terephthalate contained in the sheath 11 is preferably equal to or greater than 5 parts by mass and equal to or less than 30 parts by mass. In this case, adhesiveness between the sheath 11 and the resin molded body 7 is higher.

When the total mass of the resin contained in the sheath 11 is 100 parts by mass, the mass of the polyester-based thermoplastic elastomer contained in the sheath 11 is preferably equal to or greater than 5 parts by mass and equal to or less than 30 parts by mass. In this case, adhesiveness between the sheath 11 and the resin molded body 7 is higher.

The sheath 11 may contain or need not contain a component that is not any of the thermoplastic polyurethane, the acrylic thermoplastic elastomer, the polybutylene terephthalate, and the polyester-based thermoplastic elastomer (hereinafter, called the other component of the sheath). Examples of the other component of the sheath include general compounding agents such as an anti-aging agent, a plasticizer, a lubricant, a filler, a flame retardant, a stabilizer, and a colorant. The other component of the sheath may be a resin or rubber.

The sheath 11 is preferably a non-crosslinked insulation member that is not crosslinked. When the sheath 11 is not crosslinked, the adhesiveness between the sheath 11 and the resin molded body 7 is higher.

The resin molded body 7 contains polybutylene terephthalate. The resin molded body 7 may contain or need not contain a component other than polybutylene terephthalate (e.g., a reinforcing material such as glass fiber). For example, the main component of the resin molded body 7 is polybutylene terephthalate. The main component is a component having the largest mass ratio in the resin molded body 7, for example, or a component having a mass ratio of equal to or greater than 50 mass % in the resin molded body 7.

### 2. Effects of Molded Electrical Wire 1

(1A) The sheath 11 contains a thermoplastic polyurethane and an acrylic thermoplastic elastomer. The resin molded body 7 contains polybutylene terephthalate. In the molded electrical wire 1, the adhesiveness between the sheath 11 and the resin molded body 7 is high. As a result, the molded electrical wire 1 can suppress permeation of water or the like from between the sheath 11 and the resin molded body 7.

### Second Embodiment

### 1. Configuration of Molded Electrical Wire 101

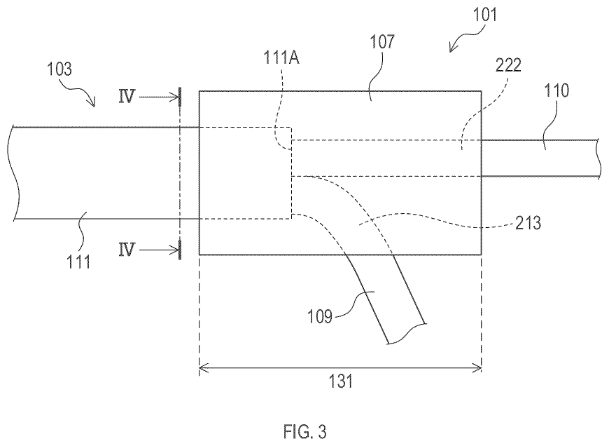

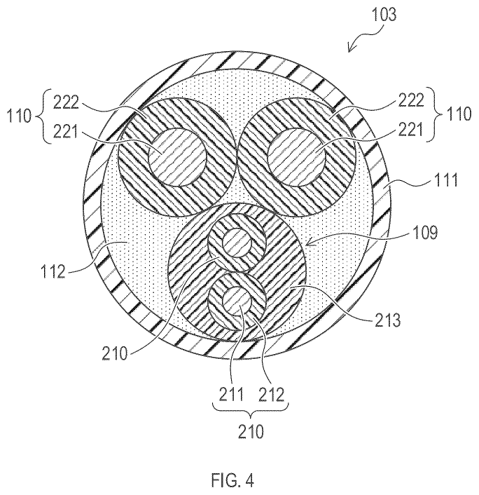

The configuration of a molded electrical wire 101 will be described with reference to FIGS. 3 and 4. The molded electrical wire 101 is an automobile component wired in a wheel house of an automobile. The molded electrical wire 101 includes a multicore cable 103 and a resin molded body 107.

The multicore cable 103 includes an anti-lock brake system (ABS) sensor cable 109, two electric parking brake (EPB) cables 110, and a sheath 111. In FIG. 3, the two electric parking brake cables 110 are arranged in a direction orthogonal to the paper surface.

The ABS sensor cable 109 is a cable used for an anti-lock brake system of an automobile. The ABS sensor cable 109 is a signal line responsible for signal transmission between a wheel speed sensor that detects the rotation speed of a wheel and an electronic control unit on a vehicle body side. The tip end of the ABS sensor cable 109 is provided with a connector for connecting to the wheel speed sensor, for example.

The electric parking brake cable 110 is a cable used in an EPB system of an automobile. The electric parking brake cable 110 is a power supply line electrically connecting an electric motor built in a brake caliper constituting a disc brake in the wheel house and a brake control unit on the vehicle body side, and supplying power for driving the brake caliper. The tip end of the electric parking brake cable 110 is provided with a connector for connecting to the electric motor built in the brake caliper, for example.

The ABS sensor cable 109 and the two electric parking brake cables 110 are covered collectively with the sheath 111. In the multicore cable 103, the sheath 111 is removed on the tip end side of an end part 111A of the sheath 111 shown in FIG. 3, and the ABS sensor cable 109 and the two electric parking brake cables 110 are exposed.

In the part where the sheath 111 is removed, the ABS sensor cable 109 branches from the two electric parking brake cables 110. In the form shown in FIG. 3, the electric parking brake cable 110 extends along a longitudinal direction of the multicore cable 103, and the ABS sensor cable 109 extends so as to deviate from the longitudinal direction of the multicore cable 103. However, the direction in which the ABS sensor cable 109 and the electric parking brake cable 110 extend may be a direction other than the direction shown in FIG. 3.

As shown in FIG. 4, in the multicore cable 103, the sheath 111 is provided around the ABS sensor cable 109 and the two electric parking brake cables 110. In order to stabilize the arrangement of the ABS sensor cable 109 and the electric parking brake cable 110, an interposition 112 may be provided in a gap between the ABS sensor cable 109 and the electric parking brake cable 110. A press-wound tape may be wound around the ABS sensor cable 109 and the electric parking brake cable 110.

The ABS sensor cable 109 includes two ABS cables 210 and a sheath 213 provided around them. Each of the two ABS cables 210 includes a conductor wire 211 having a linear shape and an insulator 212. The insulator 212 directly covers the outer circumference of the conductor wire 211.

The conductor wire 211 is made of a conductive material such as copper or includes a conductive material such as copper. The insulator 212 is made of an insulating material such as crosslinked polyethylene or a crosslinked ethylene-vinyl acetate copolymer or includes an insulating material such as crosslinked polyethylene or a crosslinked ethylene-vinyl acetate copolymer. The material of the insulator 212 may contain a flame retardant.

Each of the two electric parking brake cables 110 includes a conductor wire 221 having a linear shape and an insulator 222. The insulator 222 directly covers the outer circumference of the conductor wire 221. The conductor wire 221 is made of a conductive material such as copper or includes a conductive material such as copper.

The sheath 111, the sheath 213, and the insulator 222 are each made of the same material as that of the sheath 11 in the first embodiment or each include the same material as that of the sheath 11 in the first embodiment. The sheath 111 corresponds to an insulation member indirectly covering the outer circumference of the conductor wire 211 and the outer circumference of the conductor wire 221. The sheath 213 corresponds to an insulation member indirectly covering the outer circumference of the conductor wire 211. The insulator 222 corresponds to an insulation member directly covering the outer circumference of the conductor wire 221.

The sheath 111, the sheath 213, and the insulator 222 are preferably non-crosslinked insulation members that are not crosslinked. When the sheath 111, the sheath 213, and the insulator 222 are not crosslinked, adhesiveness among the sheath 111, the sheath 213, and the insulator 222 and the resin molded body 107 is higher.

As shown in FIG. 3, the resin molded body 107 directly covers a branch part 131 of the multicore cable 103. The branch part 131 includes a part where the sheath 111 exists and a part where the sheath 111 is removed. In the branch part 131, the ABS sensor cable 109 branches from the two electric parking brake cables 110. The resin molded body 107 maintains a state in which the ABS sensor cable 109 branches from the two electric parking brake cables 110.

The resin molded body 107 directly covers the sheath 111 in a part where the sheath 111 exists. The resin molded body 107 covers an end part of the sheath 111. The resin molded body 107 directly covers the sheath 213 and the insulator 222 in a part where the sheath 111 is removed.

The ABS sensor cable 109 and the two electric parking brake cables 110 correspond to a plurality of insulated electrical wires. The resin molded body 107 collectively covers the plurality of insulated electrical wires. The resin molded body 107 is made of the same material as that of the resin molded body 7 in the first embodiment or include the same material as that of the resin molded body 7 in the first embodiment.

### 2. Effects of Molded Electrical Wire 101

(2A) Each of the sheath 111, the sheath 213, and the insulator 222 contains a thermoplastic polyurethane and an acrylic thermoplastic elastomer. The resin molded body 107 contains polybutylene terephthalate. In the molded electrical wire 101, the adhesiveness among the sheath 111, the sheath 213, and the insulator 222 and the resin molded body 107 is high. As a result, the molded electrical wire 101 can suppress permeation of water or the like from between the sheath 111 and the resin molded body 107, between the sheath 213 and the resin molded body 107, and between the insulator 222 and the resin molded body 107.

(2B) The molded electrical wire 101 includes the ABS sensor cable 109 and the two electric parking brake cables 110. Each of them corresponds to an insulated electrical wire including a conductor wire and an insulation member.

In the part of the branch part 131 from which the sheath 111 is removed, the ABS sensor cable 109 and the two electric parking brake cables 110 are covered collectively with the resin molded body 107. Therefore, the molded electrical wire 101 can enhance the adhesiveness among the sheath 213 and the insulator 222, and the resin molded body 107.

### Examples

### 1. Configuration of Sample 301

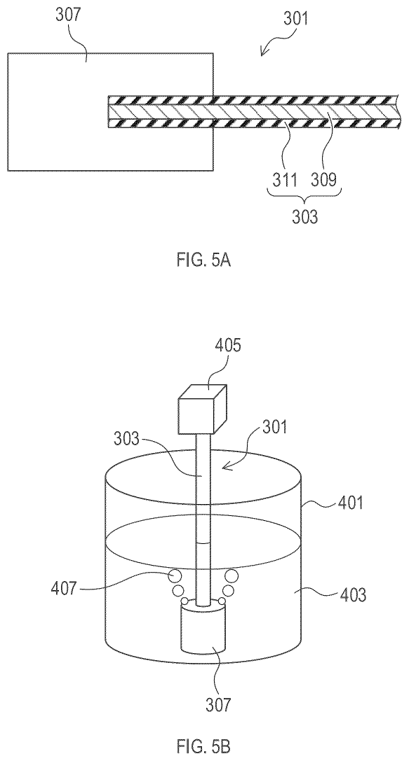

A sample 301 shown in FIG. 5A was prepared for each of Examples 1 to 6 and Comparative Example 1. The samples 301 of Examples and Comparative Example 1 were different only in the material of the insulator 311 described later, and were identical in the other points.

The sample 301 was composed of an insulated electrical wire 303 and a resin molded body 307. The insulated electrical wire 303 included a conductor wire 309 having a linear shape and an insulator 311. The insulator 311 directly covered the outer circumference of the conductor wire 309. The conductor wire 309 was a stranded wire including seven copper conductor wires having a diameter of 0.26 mm. Air could pass through the inside of the conductor wire 309. The thickness of the insulator 311 was 0.36 mm. The outer diameter of the insulator 311 was 1.5 mm.

The resin molded body 307 had a cylindrical shape with a diameter of 6 mm and a length of 20 mm. The resin molded body 307 directly covered an end part of the insulated electrical wire 303. The resin molded body 307 directly covered the insulator 311. A central axis of the resin molded body 307 coincided with a central axis of the insulated electrical wire 303. The length of a part of the insulated electrical wire 303, which was covered with the resin molded body 307, was 10 mm in the longitudinal direction of the insulated electrical wire 303. The materials of the insulated electrical wire 303 in Examples and Comparative Example 1 were blended as shown in Table 1. The unit of the blending amounts of the materials of the insulated electrical wire in Table 1 is parts by mass. The insulators 311 of Examples and Comparative Example 1 were not crosslinked.

TABLE 1

| | | | | | | | | Comparative |
|---|---|---|---|---|---|---|---|---|
| | | Examples | | | | | | Example |
| | | 1 | 2 | 3 | 4 | 5 | 6 | 1 |
| Material | Thermoplastic polyurethane | 90 | 10 | 80 | 80 | 10 | 10 | 100 |
| of | Acrylic thermoplastic elastomer | 10 | 90 | 10 | 10 | 80 | 80 | |
| insulator | Polybutylene terephthalate | | | 10 | | 10 | | |
| | Polyester-based thermoplastic | | | | 10 | | 10 | |
| | elastomer | | | | | | | |

| | | | | | | | |
|---|---|---|---|---|---|---|---|
| Evaluation results of airtightness | ◯ | ◯ | ⊚ | ⊚ | ⊚ | ⊚ | X |

The thermoplastic polyurethane in Table 1 was Elastollan 1180A (trade name) manufactured by BASF. The acrylic thermoplastic elastomer in Table 1 was KURARITY LA2250 (trade name) manufactured by KURARAY CO., LTD. The polybutylene terephthalate in Table 1 was NOVADURAN 5026 (trade name) manufactured by Mitsubishi Chemical Corporation. The polyester-based thermoplastic elastomer in Table 1 was Hytrel 3046 (trade name) manufactured by Toray Celanese Co., Ltd.

### 2. Evaluation of Airtightness

Airtightness was evaluated for each of Examples and Comparative Example 1. The airtightness was evaluated by alternately repeating a thermal shock treatment and an airtightness test on the sample 301. That is, the thermal shock treatment, the airtightness test, the thermal shock treatment, the airtightness test, the thermal shock treatment, the airtightness test . . . were repeated.

The thermal shock treatment was a treatment of repeating 100 cycles of temperature change. One cycle consisted of standing in the atmosphere at −40° C. for 30 minutes followed by standing in the atmosphere at 120° C. for 30 minutes.

The airtightness test was performed as follows. As shown in FIG. 5B, a part of the sample 301 on the resin molded body 307 side was immersed in water 403 stored in a water tank 401. The entire resin molded body 307 was immersed in the water 403. A part of the insulated electrical wire 303, which was not covered with the resin molded body 307, was also immersed in the water 403. An end part 303A of the insulated electrical wire 303 opposite to the resin molded body 307 was not immersed in the water 403. An air feeder 405 was connected to the end part 303A.

In this state, air was supplied from the air feeder 405 to the inside of the conductor wire 309. The supplied air passed through the inside of the conductor wire 309 and proceeded in the direction toward the resin molded body 307. When air bubbles 407 leaked out from an adhesive surface between the resin molded body 307 and the insulator 311, it was determined that airtightness between the resin molded body 307 and the insulator 311 was lost. When the air bubbles 407 did not leak from the adhesive surface between the resin molded body 307 and the insulator 311, it was determined that airtightness between the resin molded body 307 and the insulator 311 was not lost. In one airtightness test, compressed air of 200 kPa was supplied from the air feeder 405 for 30 seconds.

Airtightness between the resin molded body 307 and the insulator 311 was evaluated according to the following criteria.
⊚: At the time when the airtightness was lost, the cumulative number of cycles of temperature change was 2000 or more.
∘: At the time when the airtightness was lost, the cumulative number of cycles of temperature change was 1000 or more and 1999 or less.
x: At the time when the airtightness was lost, the cumulative number of cycles of temperature change was less than 1000.

The evaluation results are shown in Table 1. In each of Examples, the evaluation result of airtightness was good. In Examples 3 to 6, the evaluation result of airtightness was even better. In Comparative Example 1, the evaluation result of airtightness was poor. The better the adhesiveness between the resin molded body 307 and the insulator 311 is, the better the evaluation result of airtightness is.

### Other Embodiments

Although embodiments of the present disclosure have been described above, the present disclosure is not limited to the above-described embodiments, and can be carried out in various modifications.

(1) In the first embodiment, for example, in addition to the sheath 11, the insulator 15 may also contain a thermoplastic polyurethane and an acrylic thermoplastic elastomer. In this case, the adhesiveness between the insulator 15 and the resin molded body 7 is also high.

In the first embodiment, not the sheath 11 but the insulator 15 may contain a thermoplastic polyurethane and an acrylic thermoplastic elastomer. In this case, the adhesiveness between the insulator 15 and the resin molded body 7 is high.

In addition to the thermoplastic polyurethane and the acrylic thermoplastic elastomer, the insulator 15 may further contain one or both of polybutylene terephthalate and a polyester-based thermoplastic elastomer.

The insulator 15 is preferably not crosslinked. When the insulator 15 is not crosslinked, the adhesiveness between the insulator 15 and the resin molded body 7 is higher.

(2) In the second embodiment, for example, one or two of the sheath 111, the sheath 213, and the insulator 222 may contain a thermoplastic polyurethane and an acrylic thermoplastic elastomer. Examples of a combination containing a thermoplastic polyurethane and an acrylic thermoplastic elastomer include a combination of the sheath 111 and the sheath 213, a combination of the sheath 213 and the insulator 222, and a combination of the sheath 111 and the insulator 222.

(3) A function of one constituent element in each of the above embodiments may be shared by a plurality of constituent elements, or a function of a plurality of constituent elements may be exerted by one constituent element. A part of the configuration of each of the above embodiments may be omitted. At least a part of the configuration of each of the above embodiments may be added to, replaced with, or the like with respect to the configuration of the other of the above embodiments.

(4) The present disclosure can be achieved in various forms such as a system including the molded electrical wire 1 or 101 as a constituent element and a method of manufacturing the molded electrical wire 1 or 101 in addition to the molded electrical wires 1 and 101 described above.

What is claimed is:

1. A molded electrical wire comprising:
a conductor wire;
a non-crosslinked insulation member covering an outer circumference of the conductor wire; and
a resin molded body directly covering the insulation member, wherein
the insulation member contains a thermoplastic polyurethane and an acrylic thermoplastic elastomer, and
the resin molded body contains polybutylene terephthalate.

2. The molded electrical wire according to claim 1, wherein
the insulation member further contains polybutylene terephthalate.

3. The molded electrical wire according to claim 1, wherein
the insulation member further contains a polyester-based thermoplastic elastomer.

4. The molded electrical wire according to claim 1, wherein
the insulation member is an insulator directly covering the outer circumference of the conductor wire.

5. The molded electrical wire according to claim 1, wherein
the insulation member is a sheath indirectly covering the outer circumference of the conductor wire.

6. The molded electrical wire according to claim 1 comprising
a plurality of insulated electrical wires including the conductor wire and the insulation member, wherein
the plurality of insulated electrical wires are covered collectively with the resin molded body.
